(19) United States
(12) Patent Application Publication
(10) Pub. No.: US 2006/0186144 A1
(43) Pub. Date: Aug. 24, 2006

(54) Sure shot system

(76) Inventor: Michael Ross Tinsley, Frankfort, KY (US)

Correspondence Address: MICHAEL R. TINSLEY SR., # 10 PIN OAK SQUARE, FRANKFORT, KY, 40601, US

(21) Appl. No.: 11/060,792

(22) Filed: Feb. 18, 2005

(51) Int. Cl. B67D 5/40; B67D 5/60

(52) U.S. Cl. 222/377; 222/382; 222/464.7

(57) ABSTRACT

A plastic spray bottle use for spraying multipurpose cleaners, window cleaners, furniture cleaners and other liquid agents has a slanted inner wall(s) that slopes to the debit that brings all the liquid agent to a focus point. The slanted wall acts as a funnel that channel the liquid spraying agent around the suction tube to ensure the user the maximum spraying results every time the trigger is squeezed. This will allow the entire contents of the bottle to be dispensed with minimal effort.

### REFERENCES CITED

| | | | |
|---|---|---|---|
| 3083875 | 4/1963 | Welty et al. | — |
| 4470526 | 9/1984 | Cha et al. | 222/320 |
| 4762241 | 8/1988 | Lang | 215/250 |
| 4819835 | 4/1989 | Tasaki | 222/383 |
| 4830235 | 5/1989 | Miller | 222/464 |
| 4969585 | 11/1990 | Hester | 222/434 |
| 5062549 | 11/1991 | Smith | 222/377 |
| 5464129 | 11/1995 | Ho | 222/377 |
| DES 388710 | 1/1998 | Grunig | D9/543 |

### FIELD OF THE INVENTION

This invention relates generally to plastic spray bottle and more particularly to plastic bottles having a slanted inner wall(s) that forms a debit at the bottom of the bottle, to channel the liquid agent around the suction tube opening. This reduces the surface area of the conventional spray bottle and makes for a more efficient tool for dispensing your liquid product (what have you).

### BACKGROUND OF THE INVENTION

A background of relevant information may be gained from a review of the following U.S. patents:

U.S. Pat. No. 4,969,585

U.S. Pat. No. 5,062,549

U.S. Pat. No. 5,464,129

U.S. Pat. No. 3,083,875

DES388,710

U.S. Pat. No. 4,470,526

U.S. Pat. No. 4,819,835

U.S. Pat. No. 4,830,235

U.S. Pat. No. 4,762,241

The problems with conventional spray bottles are the surface area at the bottom of the bottle is too large of area when the bottle is near empty. Thus causing insufficient amount of suction when the trigger is applied, causing oozing, misfire, foaming and tilting the bottle in obscure angles to get at the liquid agent in the spray bottle. The slanted inner wall(s) that form the debit at the bottom of the bottle will reduce the surface area to the focus point so that the suction tube will be used more efficiently. This will eliminate the oozing, misfire, foaming, and tilting the bottle to get the liquid product (cleanser) under the suction opening.

Another problem associated with conventional spray bottles is that some of the product is wasted. For example, conventional window cleaner spray bottle contains a suction tube in the center of the bottle for drawing the liquid agent up and into the spray mechanism. The tube stops short of the bottom of the bottle so that the bottom does not block liquid from flowing into the suction tube. Thus, when the bottle is almost empty, any liquid below the tube will remain in the bottle. The debit will ensure that all the cleanser will be dispensed so there will be no more wasting of product. It does that by shortening the distance from the end of the suction tube to the cleanser.

### SUMMARY OF THE INVENTION

The present invention (Sure Shot System) address this problem by providing an improved hand held dispenser for liquid cleaners which comprises: a container with a slanted inner wall(s) forming a debit to localize the cleaning agent at a focus point around the suction tube for more efficient use. The slanted inner wall(s) will reduce the surface area to prevent tilting the bottle in obscure angles to get at the liquid cleansing agent. Also it will prevent oozing, foaming, and misfire by ensuring the maximum amount of suction is created when the trigger is squeezed.

### BRIEF DESCRIPTION OF THE DRAWING

FIG. 3. Depicts the interior change of the spray bottle in 3 dementional transparent form (slanted inner wall(s) that form the debit center middle bottom of the bottle).

FIG. 13. The shaded area depicts the new interior shape of the spray bottle depicted in FIG. 3.

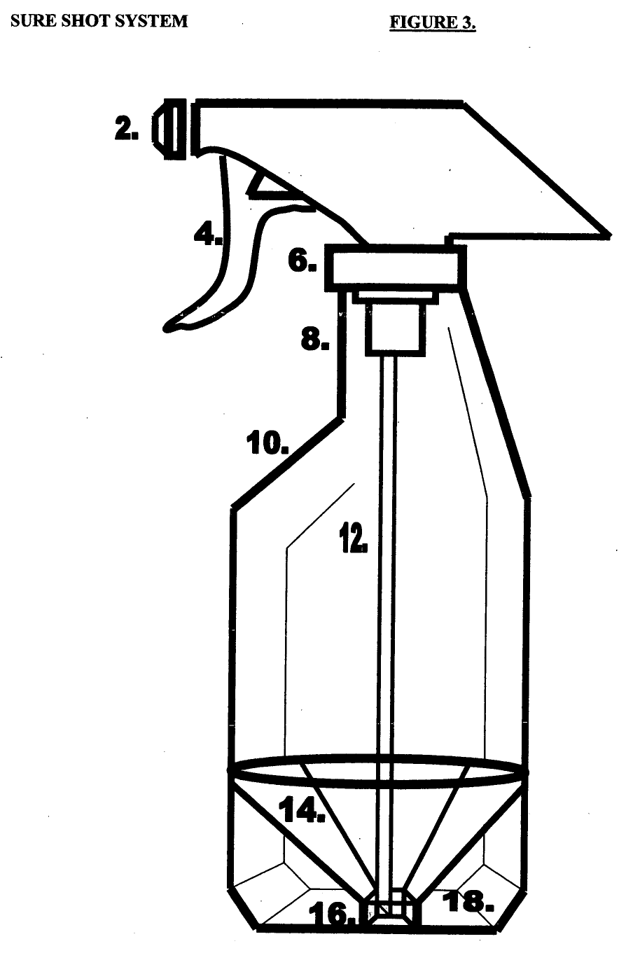

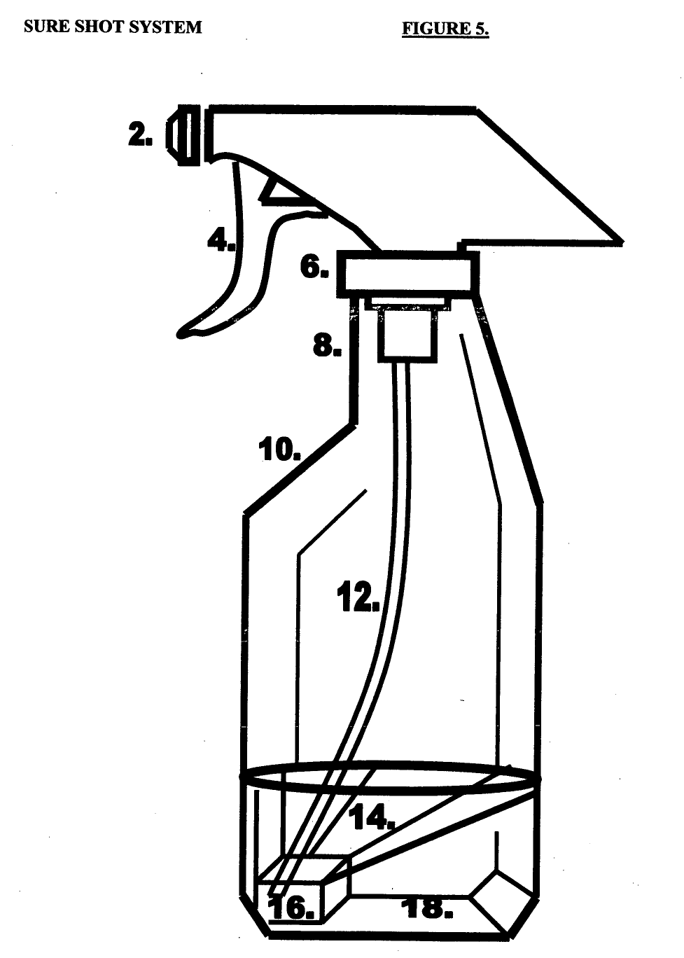

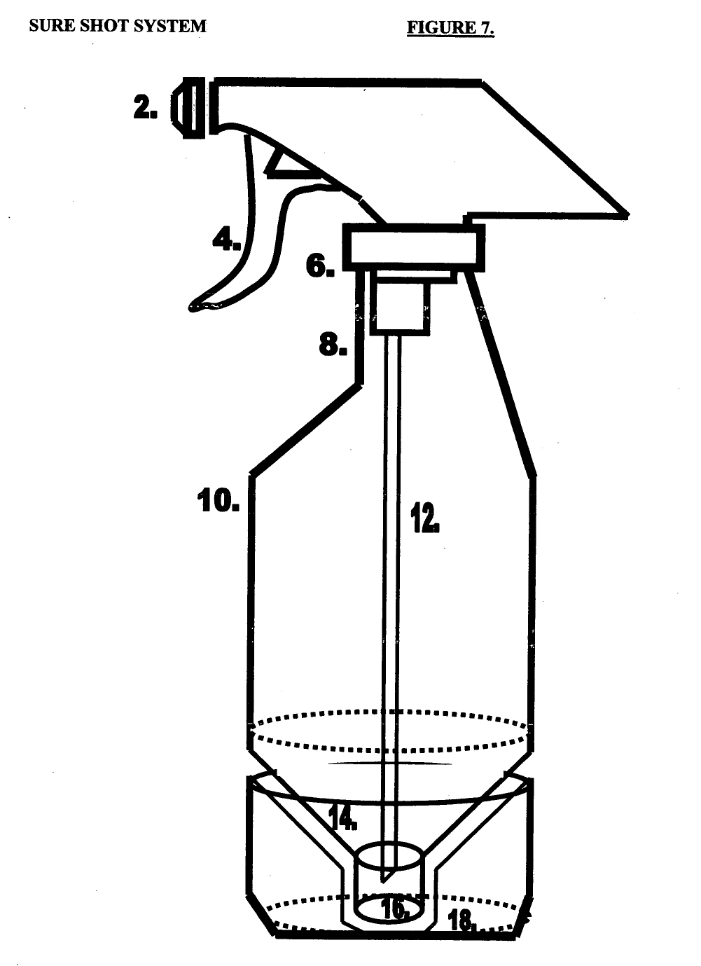

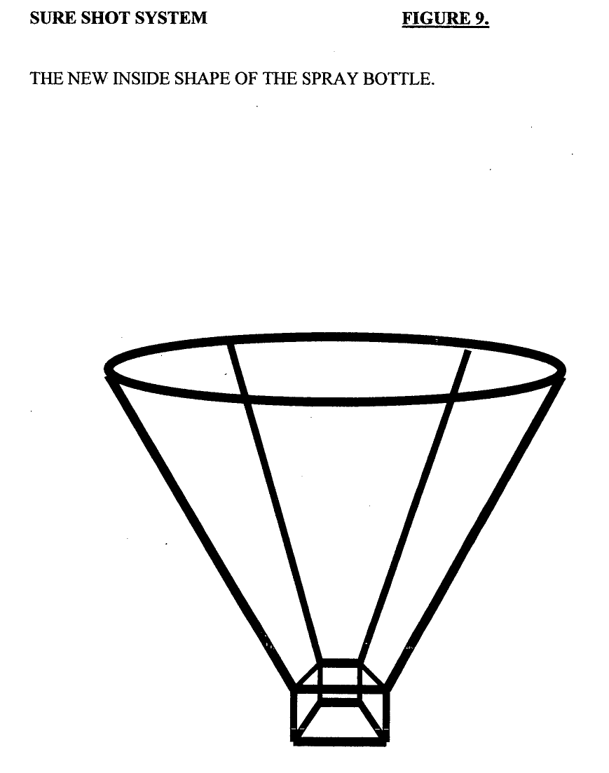

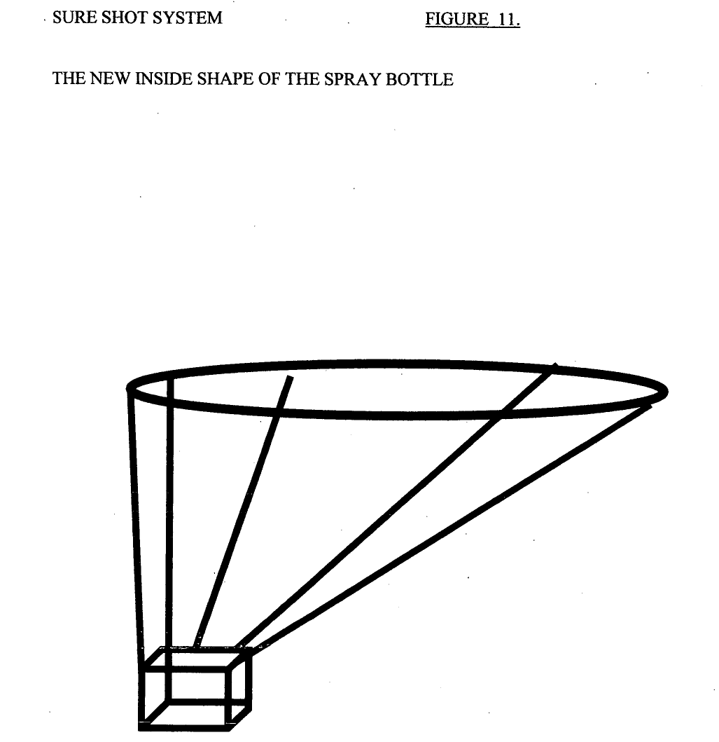

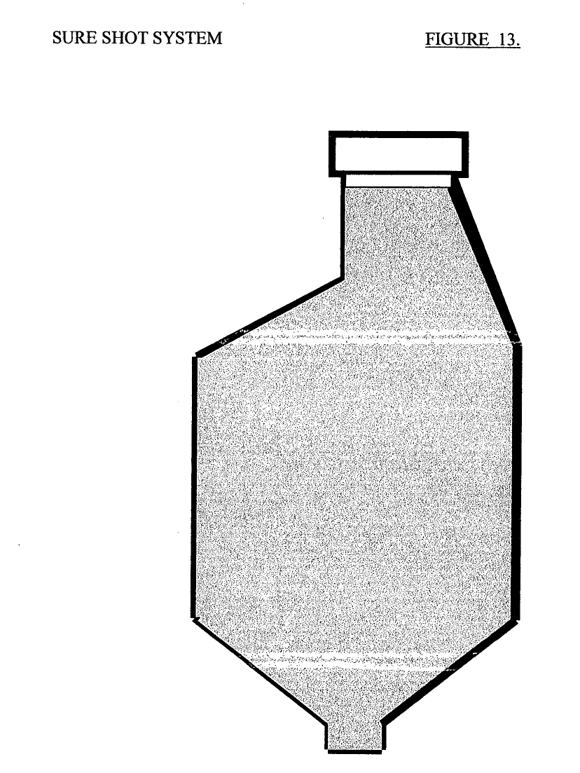

FIG. 9. The new inside shape of the spray bottle depicted in FIG. 3.

FIG. 5. Depicts the interior change of the spray bottle in 3 dementional transparent form (slanted inner wall(s) the form the debit at the center middle bottom along the Side).

FIG. 11. The new inside shape of the spray bottle depicted in FIG. 5.

FIG. 15. The shaded area depicts the new interior shape of the spray bottle depicted in FIG. 5.

FIG. 7. Depicts the interior and outer change of the spray bottle with a screw on bottom.

FIG. 17. The shaded area depicts upper half interior and outer change depicted in FIG. 7

FIG. 21. The conventional spray bottle surface area differential.

FIG. 23. The side bottom view of the conventional spray bottle.

FIG. 19. The new inside surface area of the spray bottom

### LIST OF REFERENCE NUMBERS

2 NOZZLE
4 SPRAY TRIGGER
6 SCREW CAP
8 BOTTLE NECK
10 BODY
12 SUCTION TUBE
14 SLANTED ENTER WALL
16 DEBIT
18 BOTTLE SURFACE AREA
20 FRONT SIDE OF THE BOTTLE
22 BOTTOM HALF
24 SCREW HOLE
26 DIRECTION OF THE SPRAY HEAD TO BE SCREWED ON

### DETAIL DESCRIPTION OF THE DRAWINGS

An alternative embodiment of the conventional spray bottle, liquid dispenser of the present invention (Sure Shot System) is shown in FIGS. 3, 5 and 7 also comprises a container 10 having slanted inner wall(s) 14 leading to a debit 16 that reduces the surface area 18. The debit 16 shown in FIGS. 3, 5 and 7 extending upward from the bottom 18 and gradually slopes 14 upward to the walls of the container 10, FIGS. 3, 5 and 7 interior design are different but still functions the same as FIGS. 9 and 11.

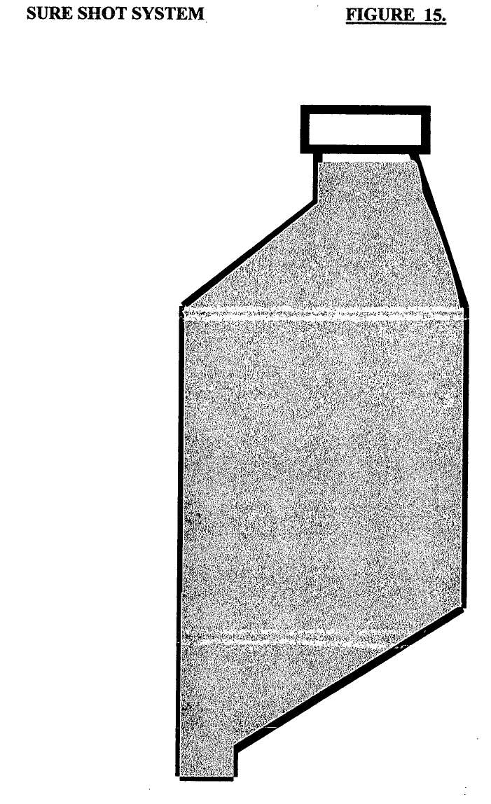

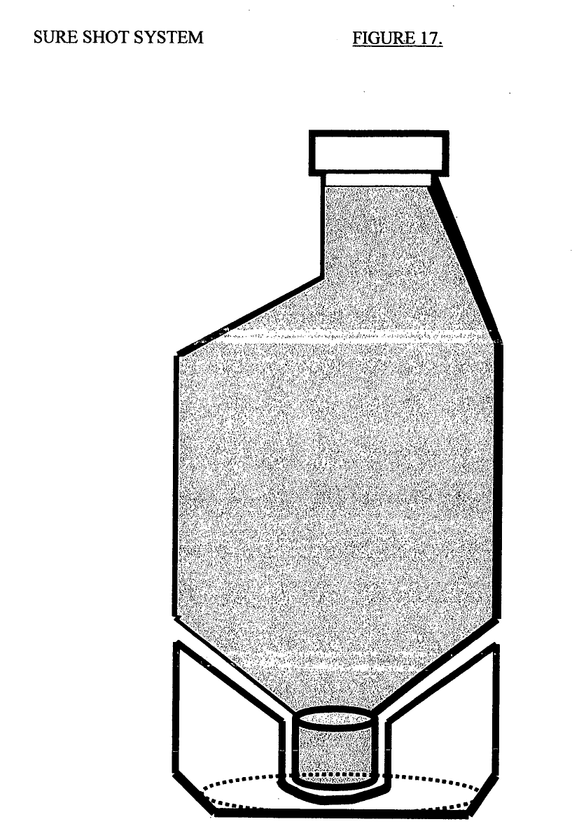

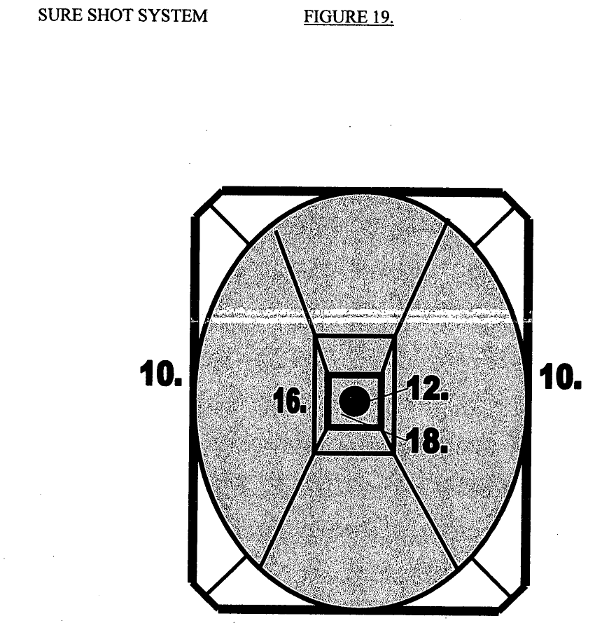

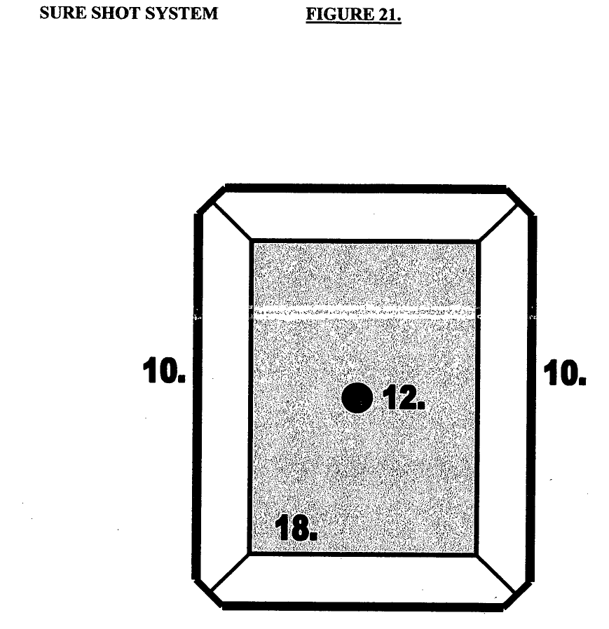

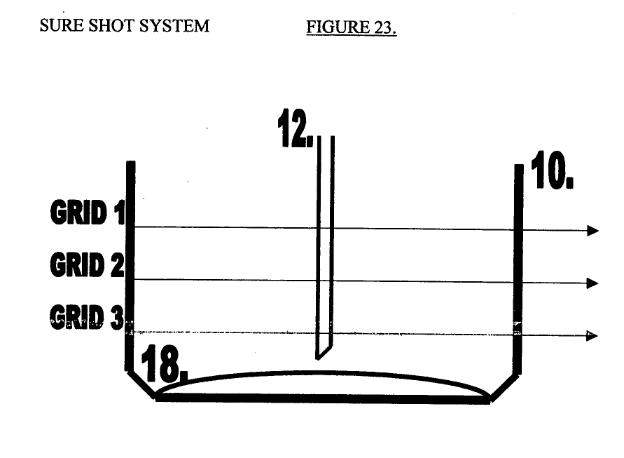

FIG. 9 debit 16 extends upward from the center middle bottom 18 of the bottle 10 and gradually slopes upward to the wall of the container 10 forming a v-shape 14 with a dip bottom 16 see FIG. 13.

FIG. 11 debit 16 extends upward from the center middle side and gradually slopes 14 upward to the wall of the container forming a half v-shape with a dip bottom see FIG. 15. The primary difference between the embodiment of the new design (Sure Shot System) compared with the conventional spray bottle must be noted in the shape of the interior container and also the functions.

Generally manufactures of conventional spray bottle produce suction tubes 12 that falls straight down or to the side of the bottom 18 of the conventional spray bottle just stopping short of the bottom. The suction tube 12 shown in FIGS. 3, 5 and 7 work the same as in a conventional spray bottle, but the debit 16 will ensure that the liquid agent (cleanser) will remain under the suction tube unlike the conventional spray bottle. FIG. 7 is a modified version of the FIGS. 3 and 5, it works the same but there is a physical change to the embodiment of the spray bottle. The change is a screw on bottom 22 that secures on the debit 16 to give the spray bottle its conventional shape with its new interior change 14 see FIG. 17. This Sure Shot System design depicted in FIG. 7 has two openings at the top and bottom of the bottle. At the top, the spraying mechanism (trigger) 4 has no new physical changes and operates the same as the conventional spray bottle. The new change comes at the bottom of the spray bottle, where at the bottom of the bottle the base able to be screwed on and off.

The purpose of the drawings in FIGS. 19 and 21 will compare the surface area of the conventional spray bottle with the new propose surface area design (Sure Shot System). FIG. 19 surface area is greatly reduces by the inner slanted wall(s) 14 forming a debit 16 at the bottom of the spray bottle. The surface area of a conventional spray bottle could be 5″×2½″ or bigger, where as the new propose design reduces the surface area by 90% without reducing the amount of product (spraying agent) used by the consumer.

Note: Reducing the surface area helps localize the spaying agent directly under the suction tube 12, this will ultimately eliminate wastage of the spraying agent and misfiring of the spraying mechanism (trigger) 4.

The two main problems with the conventional spray bottle are wastage of the product and the frustrating tilting by the consumer when the spraying agent gets low.

FIG. 23 show the grid levels of the conventional spray bottle. Anything just above grid 1 works straight up and down and at a 45-degree angle. Anything between grid 1 and 2 works straight up and down and at a 75 degree angle. Anything between grid 2 and 3 will work only straight up and down and there are still 20% of the product left at this point. Anything below grid 3 can not be obtained by the consumer without taking the top of the spray bottle off. The slanted inner wall(s) 14 channels the spraying agent into the debit 16, so at any level, tilted or straight up and down the consumer will be able to obtain the spraying agent by applying the spraying mechanism (trigger) 4 and the consumer will not waste any of the product.

The suction tube 12 is placed close to the bottom 18 of the spray bottle but any spraying agent below grid 1 shown in FIG. 23 can not be obtained by the consumer if the spray bottle is tilted beyond 75 degrees.

When the suction tube 12 is placed close to the bottom of the spray bottle but surrounded by the debit 16. This will allow the consumer to tilt the spray bottle 135 degrees and still apply the spraying mechanism (trigger) 4 successfully. Since the “Sure Shot System would represent a modification of an existing product, it would be readily producible. The “Sure Shot System could be produce from polystyrene and injection molding might be a standard approach to production. The spray tube or suction tube could be formed from flexible, injection-molded polyethylene. The package could have a label printed in one or more colors (including four-color process) on a pressure-sensitive paper stock. The label could give the product name, manufacturer, and instructions for use, and listing of ingredients.

What is claimed is:

1. The plastic spray bottle (Sure Shot System) comprises of:
a. A slanted wall on the inside of the bottle.
b. A slanted wall that forms a debit.

2. The suction tube falls into the debit.

2a. The slanted walls channel the liquid spraying agent into the debit.

3. The debit can be at the center middle bottom of the bottle.

3a. The debit can be at the side middle at the bottom of the bottle.

4. The slanted inner wall/debit can take shape to any bottle (cylindrical, rectangular, octagonal, etc . . .).

5. The slanted inner wall/debit can fit any size bottle.

6. The surface area will be greatly reduced.

6a. By reducing the surface area of the conventional spray bottle, this will help the small opening of the suction tube to work more efficiently and will eliminate tilting of the bottle

7. The debit will ensure maximum suction for the user of the spray bottle.

8. The slanted inner wall/debit will prevent oozing, misfire, foaming, and tiling the spray bottle in obscure angles to get at the liquid spraying agent when the contents is low.

9. The slanted inner wall/debit will prevent wastage of product all together.

10. The slanted inner wall/debit will prevent the consumer, the user from having to remove the top or the spraying mechanism (trigger) to get at the liquid spraying agent (cleanser) what have you inside the spray bottle.
